(19) United States
(12) Patent Application Publication
(10) Pub. No.: US 2014/0361523 A1
(43) Pub. Date: Dec. 11, 2014

(54) Photo Album

(71) Applicant: Yu Shen Wang, Temple City, CA (US)

(72) Inventor: Yu Shen Wang, Temple City, CA (US)

(21) Appl. No.: 13/912,141

(22) Filed: Jun. 6, 2013

(51) Int. Cl. B42D 1/08; B42C 11/04

(52) U.S. Cl. CPC B42D 1/08; B42C 11/04
USPC 281/21.1; 412/5

(57) ABSTRACT

An album includes an album retainer and at least one sliding arrangement. The album retainer has a front cover, a rear cover, and a plurality of album pages overlapping between the front cover and the rear cover, wherein inner edges of the album pages are bound with each other. The sliding arrangements are arranged for coupling with at least one of the front cover and the rear cover in such a manner that at least one of the front cover and the rear cover is retained in a slidably movable manner so as to provide a planar backing for the plurality of album pages when the album is at an opened position.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to an album, and more particularly to an album that comprises a sliding arrangement adapted for slidably coupling with a cover of an album retainer, so that when the album is at an opened position, a planar backing is provided and two neighboring album pages are aligned in a planar manner so as to prevent the album retainer from being damaged.

2. Description of Related Arts

An album can be used to store photos, CDs, and the like so as to record the best memories of human beings such as a development of a baby, a wedding, a travelling, and so on. A current photo album or a photo case often comprises a heavy and thick cover and a plurality of photo pages for holding the photos thereon. The current photo album has several disadvantages.

First of all, when the photo album is at an opened position, a subsequent photo page cannot be overlappedly folded on a previous photo page. When the user uses his or her hands to press the subsequent photo page on the previous photo page so as to facilitate the reading of the photos, the whole photo album may be damaged by the pressing force.

Second, the heavy and thick cover of the photo album often has a front cover panel, a back cover panel, and a spine panel extending between the front cover panel and the back cover panel. When the photo album is at the opened position, the front cover panel, the back cover panel, and the spine panel are not aligned in a surface, so that the photo pages mounted to the cover also cannot be aligned in a planar manner in the opened position for the user to view the photo pages.

In addition, some rigid materials, which have beautiful outer appearances, cannot be directly used to wrap the photo pages of the photo album. It is desired to introduce these rigid materials into the outer cover of the photo album to enhance the aesthetic appearance of the photo album.

### SUMMARY OF THE PRESENT INVENTION

The main object of the present invention is to provide an album that comprises a sliding arrangement adapted for slidably coupling with a cover page of an album retainer, so that when the album is at an opened position, a planar backing is provided and two neighboring album pages are aligned in a planar manner so as to prevent the album retainer from being damaged.

Another object of the present invention is to provide an album, wherein the album retainer comprises a front cover, a rear cover, and a plurality of intermediate album pages provided between the front cover and the rear cover, wherein the sliding arrangement comprises a sliding member slidably coupled with a rear cover of the album retainer, so that the front and rear covers are naturally brought to be aligned in a plane, so that the user can turn the intermediate album pages in a natural balanced manner.

Another object of the present invention is to provide an album, wherein each of the front and rear covers may be provided with a sliding arrangement, so that the album retainer is capable of self-adjustably sliding via the front and rear covers, and the user is capable of selecting the sliding direction of the album retainer to guide the album retainer to a position suitable for the user to view the album pages.

Another object of the present invention is to provide an album, wherein the album may comprise a photo case, wherein a floating support is mounted in the case in such a manner that when the album is at the opened position, the total album retainer is elevated by the floating support so that the album retainer is positioned above a case body of the case for the user to view the alum pages.

Another object of the present invention is to provide an album, wherein when at the closed position, the album retainer is biased against the floating supporting in such a manner that the floating support is attached to the inner bottom surface of the case, so that a receiving chamber is defined within the case for receiving and protecting the album retainer.

Another object of the present invention is to provide an album, wherein one or more receiving notches may be provided in the outer cover of the album, so that one or more cover boards with beautiful appearances can be embedded into the receiving notches for enhancing the aesthetic outer appearance of the album.

Another object of the present invention is to provide an album, wherein the structure of the sliding arrangement is simple, the manufacturing cost of the album is low, while the album is durable.

Additional advantages and features of the invention will become apparent from the description which follows, and may be realized by means of the instrumentalities and combinations particular point out in the appended claims.

According to the present invention, the foregoing and other objects and advantages are attained by an album comprising an album retainer and at least one sliding arrangement. The album retainer comprises a front cover, a rear cover, and a plurality of album pages overlapping between the front cover and the rear cover, wherein inner edges of the album pages are bound with each other. The sliding arrangements are arranged for coupling with at least one of the front cover and the rear cover in such a manner that at least one of the front cover and the rear cover is retained in a slidably movable manner so as to provide a planar backing for the plurality of album pages when the album is at an opened position.

In accordance with another aspect of the invention, the present invention provides an album, comprising a book-like album cover which comprises a front panel, a rear panel, and a spine panel extending between the front and rear panels in an edge-to-edge manner; an album retainer, wherein the album retainer comprises a front cover, a rear cover, and a plurality of album pages overlapping between the front cover and the rear cover, wherein inner edges of the album pages are bound with each other; and one or more sliding arrangements arranged for coupling with at least one of the front cover and the rear cover with the front and rear panels in such a manner that at least one of the front cover and the rear cover is retained in a slidably movable manner so as to provide a planar backing for the plurality of album pages when the album is at an opened position.

The present invention further provides a method of manufacturing an album comprising the following steps.

(a) Provide an album retainer which comprises a front cover, a rear cover, and a plurality of album pages overlapping between the front cover and the rear cover, wherein inner edges of the album pages are bound with each other.

(b) Slidably retain at least one of the front cover and the rear cover via at least one sliding arrangement so as to provide a planar backing for the plurality of album pages when the album is at an opened position

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an album according to a first preferred embodiment of the present invention.

FIG. 2 is an exploded view of the album according to the above first preferred embodiment of the present invention.

FIG. 3 is a schematic view illustrating an engagement between a sliding arrangement and a rear cover of an album retainer of the album according to the above first preferred embodiment of the present invention.

FIG. 4 is a sectional view illustrating the album being moved from an opened position to a closed position according to the above first preferred embodiment of the present invention.

FIG. 5 is a perspective view of an album according to a second preferred embodiment of the present invention.

FIG. 6 is an exploded view of the album according to the above second preferred embodiment of the present invention.

FIG. 7 is a schematic view illustrating an engagement between a sliding arrangement and a rear cover of an album retainer of the album according to the above second preferred embodiment of the present invention.

FIG. 8 is a sectional view illustrating the album being moved from the opened position to the closed position according to the above second preferred embodiment of the present invention.

FIG. 9 is a perspective view illustrating an album according to a third preferred embodiment of the present invention.

FIG. 10 an exploded view of the album according to the above third preferred embodiment of the present invention

FIGS. 11A and 11B are schematic views illustrating a sliding movement of a sliding arrangement of the album according to the above third preferred embodiment of the present invention.

FIG. 12 is a partial enlarged view illustrating the sliding arrangement of the album according to the above third preferred embodiment of the present invention.

FIG. 13 is a schematic view illustrating a cover board being installed to the album according to the above third preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

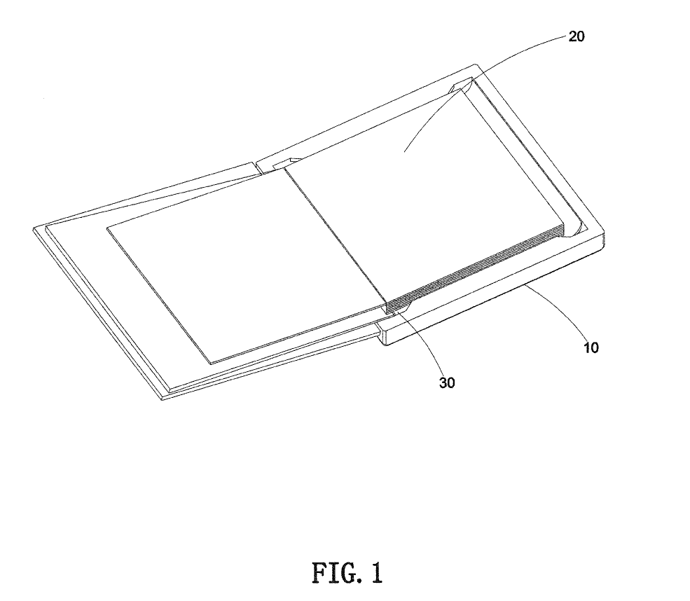

Referring to FIGS. 1 to 4 of the drawings, an album according to a first preferred embodiment of the present invention is illustrated. The album of this preferred embodiment is embodied as a photo album. More specifically, the album of this preferred embodiment, which is constructed to be a box-like structure, comprises an outer case 10, an album retainer 20, and a sliding arrangement 30.

According to this preferred embodiment, the outer case 10 comprises an upper cover 11 and a lower case body 12 engaged with the upper cover 11 to define a storing cavity 13 for storing the album retainer 20 and the sliding arrangement 30. Accordingly, in a traditional photo album which has a front cover panel, a rear cover panel, and a spine panel extended between the front cover panel and the rear cover panel, the outer edges of the album retainer of the traditional album may be exposed. However, the album retainer 20 of the album of this preferred embodiment can be sealedly stored in the storing cavity 13. Thus, the user may have a good feeling that his or her cherished memories are carefully kept in the box-like album.

The album retainer 20 comprises a front cover 21, a rear cover 22, and a plurality of album pages 23 overlapping between the front cover 21 and the rear cover 22. Inner edges of the front cover 21, the rear cover 22, and the plurality of album pages 23 are bonded with each other so that the user is able to turn from the front cover 21 to the rear cover 22 for viewing the plurality of album pages 23 when the album is at an opened position.

The album retainer 20 further comprises a plurality of edge leaves 24 connecting the inner edges of the album pages 23 respectively. Each of the edge leaves 24 is coupled between two sequent album pages at a position that the inner edges of the sequent album pages are spaced apart from each other such that two neighboring album pages are aligned in a planar manner when the neighboring album pages are folded to overlap on the front and rear covers 21 and 22 respectively at the opened position.

The sliding arrangement 30 is coupled with one of the front and rear covers 21 and 22 in a slidably movable manner. As an example, the sliding arrangement 30 of this preferred embodiment is slidably coupled with the rear cover 22, wherein when the upper cover 11 is folded at the opened position, the rear cover 22 can be slid to allow the front and rear covers 21 and 22 to form a planar backing and the album pages 23 can be turned flatly.

More specifically, the sliding arrangement 30 comprises a sliding member 31 coupling with the rear cover 22 so as to retain the rear cover 22 in the outer case 10 in a slidably movable manner. As shown in the drawings, the sliding member 31 can be embodied as a sliding panel. An outer edge of the rear cover 21 is connected to an outer edge of the sliding member 31, for example, the outer edge of the rear cover 22 is affixed to the outer edge of the sliding member 32 via glues, such that when the upper cover 11 is unfolded and the album is at the opened position to expose the album retainer 20, the rear cover 22 can be moved via the sliding member 31 to adjust its position.

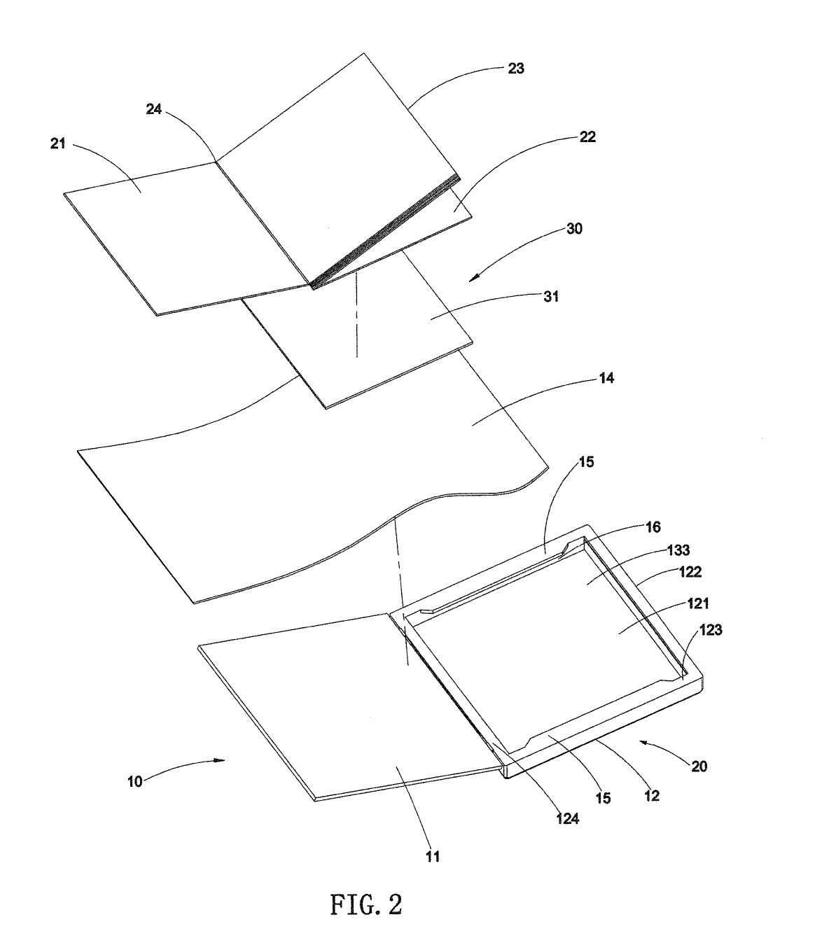

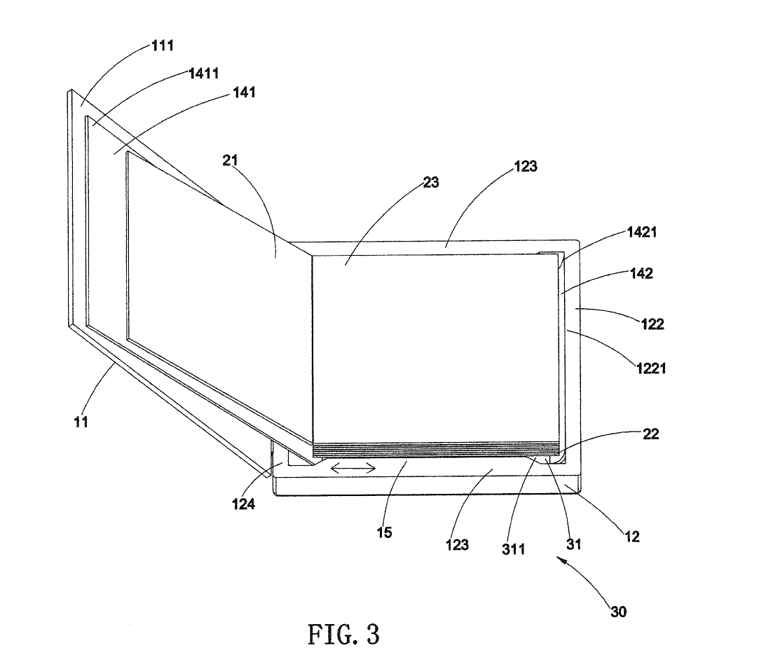

As shown in FIGS. 2 and 3 of the drawings, the album further comprises a floating support 14 provided in the outer case 10 for supporting the album retainer 20 when the album is at the opened position. More specifically, when the album is at the opened position, the album retainer 20 is elevated by the floating support 14 in such a manner that the album retainer 20 is brought to a position above the lower case body 12, so that the user is capable of conveniently viewing the album pages 23. In other words, the album retainer 20 is not embedded within the lower case body 12, so that the user is convenient to flatly turn the album pages 23. In addition, the rear cover 22 can be slid on the floating support 14 via the sliding member 31, so that the front cover 21 and the rear cover 22 can form a flat planer backing for the album pages 23. Therefore, the floating support 14 not only elevates the album retainer 20 when the upper cover 11 is unfolded to retain the album at the opened position, but also provides a flat supporting for the album retainer 20 so that the user can view the album pages 23 in a planar manner.

In other words, according to this preferred embodiment, the front cover 21 of the album retainer 20 can be directly mounted to the floating support 14, and the rear cover 22 of the album retainer 20 can slide on the floating support 14 via the sliding member 31 of the sliding arrangement 30, so that when the album is at the opened position, the front cover 21, the rear cover 22, and the floating support 14 are capable of providing a planar backing for the album pages 23 of the album retainer 20.

It is worth mentioning that the floating support 14 is mounted to the upper cover 11 and the lower case body 12 in such a manner that when the upper cover 11 is folded apart from the lower case body 12, the upper cover 11 and the lower case body 12 apply a pulling force to retain the floating support 14 in a substantial horizontal manner, so that the floating support 14 is then capable of providing the planar support for the album retainer 20. In other words, the weight of the album retainer 20 is delivered to the upper cover 11 and the lover case body 12 via the floating support 14, so that the album retainer 20 can be retained in a stable elevated position.

More specifically, the upper cover 11 defines an outer edge 111, the floating support 14 has a first support body 141 defining a first outer edge 1411 mounted to the outer edge 111 of the upper cover 11. The lower case body 12 defines an inner bottom wall 121 and a plurality of side walls extended from the inner bottom wall 121 so as to define the receiving cavity 13. More specifically, the lower case body 12 has an outer side wall 122 pivotally extended from the inner bottom wall 121, the floating support 14 has a second support body 142 defining a second outer edge 1421 inwardly mounted to an outer rim 1221 of the outer side wall 122. In other words, the floating support 14 is inwardly extended from the outer rim 1221 of the outer side wall 122 of the lower case body 12 to the outer edge 111 of the upper cover 11. Therefore, when the album is at the opened position, the outer edge 111 of the upper cover 11 and the outer rim 1221 of the outer side wall 122 of the lower case body 12 retain the floating support 14 in the elevated position.

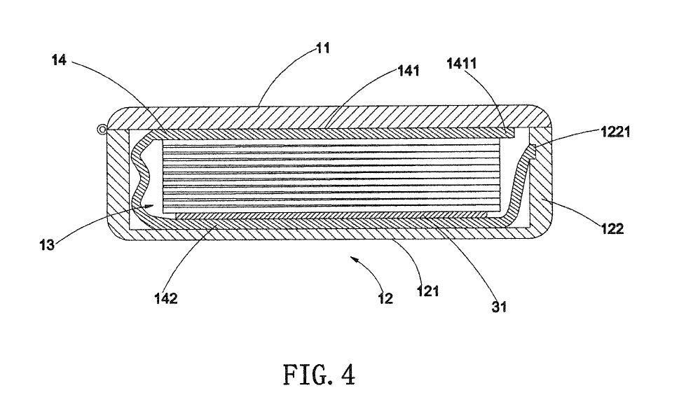

It is worth mentioning that the first support body 141 of the floating support 14 is overlappedly aligned with the upper cover 11 while the second support body 142 thereof is overlappedly aligned with the inner bottom wall 121 of the lower case body 12. As shown in FIG. 4 of the drawings, when the upper cover 11 is folded to couple with the lower case body 12 so as to sealedly store the album retainer 20, the album retainer 20 is biased against the floating support 14 in such a manner that the second support body 142 of the floating support 14 is attached to the inner bottom wall 121 of the lower case body 12 and the first support body 141 of the floating support 14 is attached to the upper cover 11, so that the receiving cavity 13 is formed to store the album retainer 20. In other words, when the upper cover 11 is unfolded to depart from the lower case body 12, the floating support 14 is elevated to support the album retainer 20, and the receiving cavity 13 is hidden below the floating support 14. When the album is at the closed position, the floating support 14 wraps around the album retainer 20B to protect the album retainer 20B.

The floating support 14 can be made of flexible material. According to this preferred embodiment, the floating support 14 can be embodied as a flexible panel. The first and second support bodies 141 and 142 can be integrated with each to form a one-piece structure.

The plurality of side walls of the lower case body 12 may further comprise two end walls 123 and an inner side wall 124. The upper cover 11 is fodalbly mounted to the inner side wall 124 so as to move between the opened position and the closed position. The outer case 10 further comprises two retention members 15 inwardly extended from the two end walls 123 respectively for retaining the sliding member 31 in the outer case 10. Accordingly, the sliding member 31 slides on the floating support 14 below the two retention members 15. In other words, the two retention members 15 are respectively coupled with the floating support 14 to define a sliding channel 16, so that the sliding member 31 slides in the sliding channels 16 to adjust the position of the rear cover 22 so as to align the rear cover 22 and the front cover 21 in a planar manner.

Accordingly, the sliding member 31 of this preferred embodiment can be embodied as a rigid sliding panel which has two peripheral edges 311 respectively received in the sliding channel 16 so that the sliding member 31 is retained in position by the two retention members 15. Each of the two retention members 15 can be embodied as an elongated edge inwardly extended from the two end walls 123 respectively. Accordingly, the two retention members 15 also prevent the further movement of the floating support 14 when the floating support 14 is elevated at the opened position. It is worth mentioning that since the elongated edges are extended in a planer manner, the floating support 14 is also retained in a planar manner by the two elongated edges.

Each of the album pages 23 can be made of photo printable material that the photo is directly printed on each of the album pages via the edge leaves 24. Alternatively, each of the album pages 23 can comprise a photo holder for retaining one or more photos being overlapped on the respective side of the album page 23. Accordingly, the photo holder can be a sheet of transparent layer overlapping on the respective side of the album page to hold the photo therebetween. It is worth mentioning that the front and rear covers 21 and 22 may also be provided with photo holders for retaining one or more photos, or may be directly printed with photos.

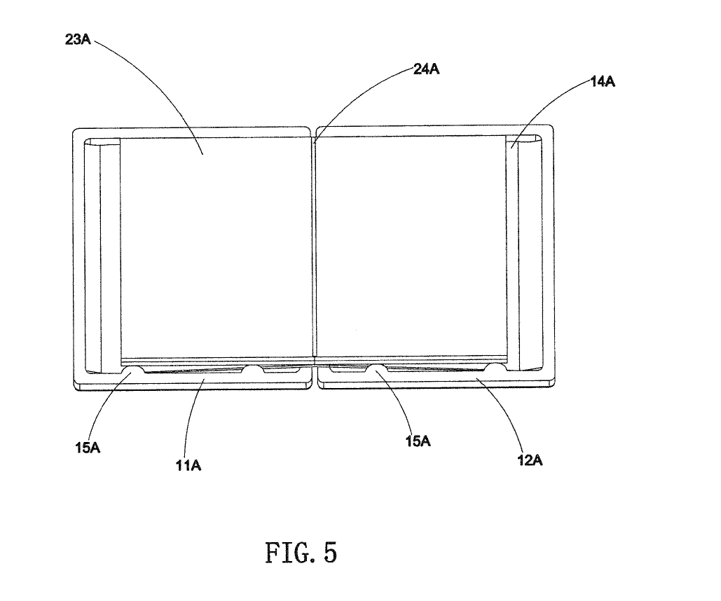

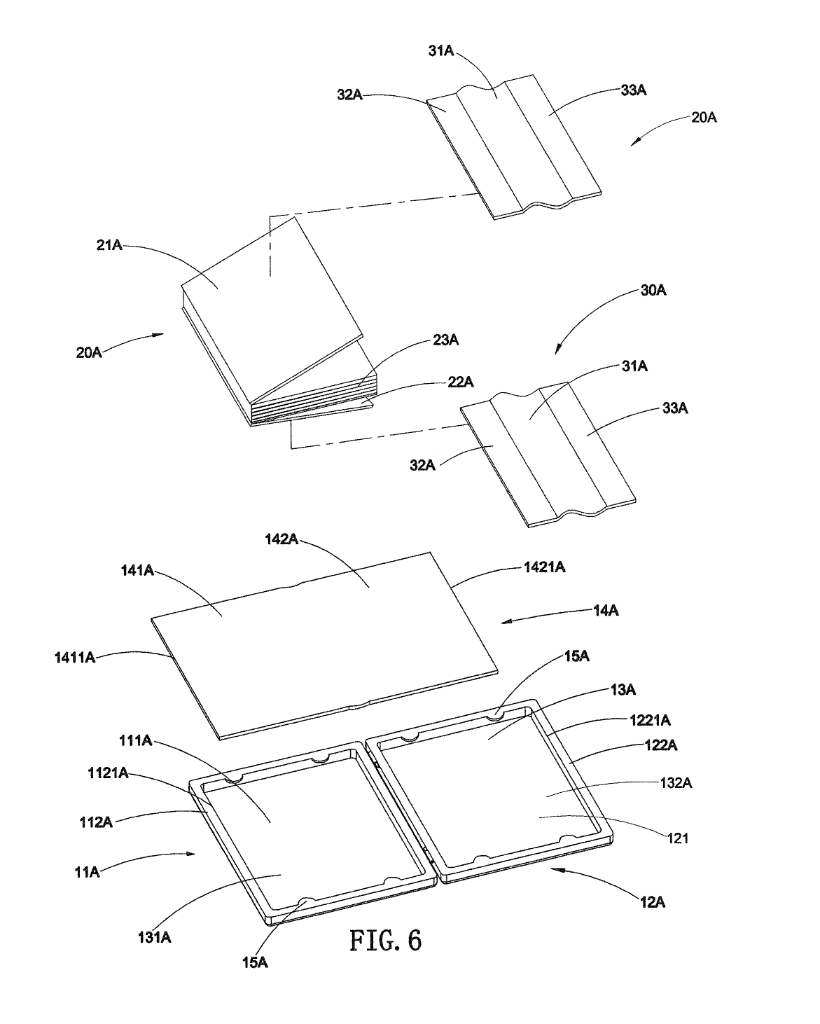

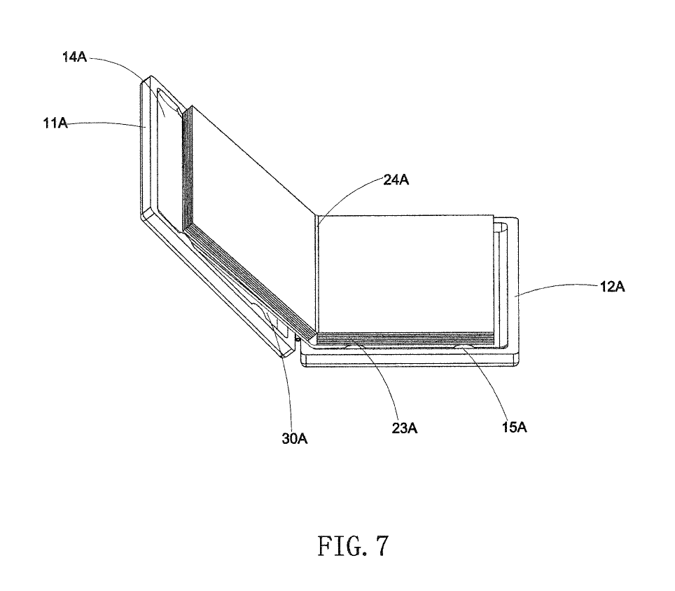

Referring to FIGS. 5 to 8 of the drawings, an album according to a second preferred embodiment of the present invention is illustrated. The album of this preferred embodiment also can be embodied as a photo album. More specifically, the album of this preferred embodiment, which is constructed to be a box-like structure, comprises an outer case 10A, an album retainer 20A, and one or more sliding arrangements 30A.

According to this preferred embodiment, the outer case 10A comprises a first case body 11A and a second case body 12A engaged with the first case body 11A to define a storing cavity 13A for storing the album retainer 20A and the sliding arrangement 30A.

The album retainer 20A comprises a front cover 21A, a rear cover 22A, and a plurality of album pages 23A overlapping between the front cover 21A and the rear cover 22A. Inner edges of the front cover 21A, the rear cover 22A, and the plurality of album pages 23A are bonded with each other so that the user is able to turn from the front cover 21A to the rear cover 22A for viewing the plurality of album pages 23A when the album is at an opened position.

The album retainer 20A further comprises a plurality of edge leaves 24A connecting the inner edges of the album pages 23A respectively, wherein each of the edge leaves 24A coupling between two sequent album pages at a position that the inner edges of the sequent album pages are spaced apart from each other such that two neighboring album pages are aligned in a planar manner when the neighboring album pages are folded to overlap on the front and rear covers 21A and 22A respectively at the opened position.

The album of this preferred embodiment comprises two sliding arrangements 30A which are respectively coupled with the front and rear covers 21A and 22A in a movable manner. When the first case body 11A is folded at the opened position to depart from the second case body 12A, the rear cover 22A and the front cover 21A can be slid to allow the front and rear covers 21A and 22A to form a planar backing, so that the album pages 23A can be turned flatly.

As shown in the drawings, the album further comprises a floating support 14A provided in the outer case 10A for supporting the album retainer 20A when the album is at the opened position. More specifically, when the album is at the opened position, the album retainer 20A is elevated by the floating support 14A in such a manner that the album retainer 20A is brought to a position above the first and second case bodies 11A and 12A, so that the user is capable of conveniently viewing the album pages 23A. In other words, the album retainer 20A is not embedded within the first and second case bodies 11A and 12A, so that the user is convenient to flatly turn the album pages 23A. In addition, the front and rear cover 21A and 22A can be slid on the floating support 14A via the sliding arrangements 30A, so that the front cover 21A and the rear cover 22A can form a flat planer backing for the album pages 23A. Therefore, the floating support 14A not only elevates the album retainer 20A when the two case bodies 11A and 12A is unfolded to retain the album at the opened position, but also provides a flat supporting for the album retainer 20A so that the user can view the album pages 23A in a planar manner.

It is worth mentioning that the floating support 14A is mounted to the first and second case bodies 11A and 12A in such a manner that when the first case body 11A is folded apart from the second case body 12A, the first and second case bodies 11A and 12A apply a pulling force to retain the floating support 14A in a substantial horizontal manner, so that the floating support 14A is then capable of providing the planar support for the album retainer 20A. In other words, the weight of the album retainer 20A is delivered to the first and second case bodies 11A and 12A via the floating support 14A, so that the album retainer 20A can be retained in a stable elevated position.

More specifically, the first case body 11A has a first receiving chamber 131A which is defined by a first inner bottom wall 111A and a plurality of, e.g. four, side walls extended from the first inner bottom wall 111A. The second case body 12A defines a second inner bottom wall 121A and a plurality of second side walls extended from the first inner bottom wall 121A so as to define a second receiving chamber 132A. Accordingly, the receiving cavity 13A of the outer case 10A is formed by the first receiving chamber 131A of the first case body 11A and the second receiving chamber 132A of the second case body 12A.

More specifically, the first case body 11A has an first outer side wall 112A pivotally extended from the first inner bottom wall 111A, the floating support 14A has a first support body 141A defining a first outer edge 1411A inwardly mounted to a first outer rim 1121A of the first outer side wall 112A, the second case body 12A has an second outer side wall 122A pivotally extended from the first inner bottom wall 121A, the floating support 14A has a second support body 142A defining a second outer edge 1421A inwardly mounted to a second outer rim 1221A of the second outer side wall 122A. Therefore, when the album is at the opened position, the first outer rim 1121A of the first outer side wall 112A and the second outer rim 1221A of the second outer side wall 122A of the second case body 12A retain the floating support 14A in the elevated position.

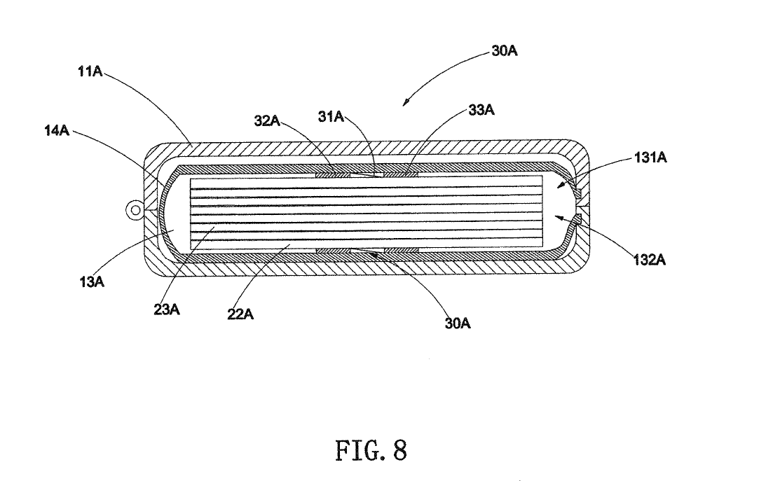

It is worth mentioning that the first support body 141A of the floating support 14A is overlappedly aligned with the first case body 11A while the second support body 142A thereof is overlappedly aligned with the second case body 12A. As shown in FIG. 8 of the drawings, when the first case body 11A is folded to couple with the second case body 12A so as to sealedly store the album retainer 20A, the album retainer 20A is biased against the floating support 14A in such a manner that the first and second support bodies 141A and 142A of the floating support 14A are respectively attached to the first inner bottom wall 111A of the first case body 11A and the second inner bottom wall 121A of the second case body 12A, so that the receiving cavity 13A is formed by the first and second receiving chambers 131A and 132A to store the album retainer 20A.

According to this preferred embodiment, the floating support 14A can be embodied as a flexible panel. The first and second support bodies 141A and 142A of the floating support 14A can be integrated with each to form a one-piece structure. Alternatively, the first and second support bodies 141A and 142A can be independent components which are respectively mounted to the first case body 11A and the second case body 12A.

It is worth mentioning that the album of this preferred embodiment of the present invention can provide two sliding arrangements 30A at a position one of the sliding arrangements 30A is provided between the front cover 21A of the album retainer 20A and the first support body 141A of the floating support 14A while another sliding arrangement 30A is provided between the rear cover 22A of the album retainer 20A and the second support body 142A of the floating support 14A. Therefore, the album retainer 20A is adapted to be self-adjustably slid at the floating support 14A.

The following description will disclose the sliding arrangement 30A provided between the rear cover 22A of the album retainer 20A and the second support body 142A of the floating support 14A. Accordingly, the sliding arrangement 30A comprises a flexible sheet 31A having two longitudinal edges coupling at an outer side of the rear cover 22A and an inner side of the floating support 14A to retain the rear cover 22A being overlapped on the floating support 14A in a slidably movable manner.

As shown in the drawings, the flexible sheet 31A, having an elongated structure, defines two longitudinal edges extending in a parallel manner and coupling at mid-sections of the rear cover 22A and the floating support 14A respectively. Accordingly, the flexible sheet 31A is overlappedly sandwiched between the rear cover 22A and the floating support 14A. When the first case body 11A is folded away from the second case body 12A so that the front cover 21A and the rear cover 22A are aligned to form the flat planar backing, the flexible sheet 31A is folded up-side-down to overlappedly sandwiched between the rear cover 22A and the floating support 14A. In other words, when the first case body 11A is coupled with the second case body 12A at the closed position, a first side of the flexible sheet 31A is overlapped with the outer side of the rear cover 22A while an opposite second side of the flexible sheet 31A is overlapped with the inner side of the floating support 14A. When the first case body 11A is disengaged with the second case body 12A to expose the album retainer 20A at the opened position, the first side of the flexible sheet 31A is overlapped with the inner side of the floating support 14A while the second side of the flexible sheet 31A is overlapped with the outer side of the rear cover 22A. Therefore, the reversible folding movement of the flexible sheet 31A enables the album pages 23A being slidably shifted on the floating support 14A.

In addition, the sliding arrangement 30A further comprises a first retention sheet 32A overlappedly affixed to the outer side of rear cover 22A to retain one of the longitudinal edges of the flexible sheet 31A in position, and a second retention sheet 33A overlappedly affixed to the inner side of the floating support 14A to retain another longitudinal edge of the flexible sheet 31A in position, such that the first and second retention sheets 32A, 33A hold the rear cover 22A being overlapped on the floating support 14A in a slidably movable manner.

Accordingly, when the flexible sheet 31A is coupled between the floating support 14A and the rear cover 22A, the flexible sheet 31A may be detached from one of the floating support 14A and the rear cover 22A accidentally by an excessive pulling force. Therefore, when the first and second retention sheets 32A, 33A are mounted at the rear cover 22A and the floating support 14A respectively, the longitudinal edges of the flexible sheet 31A can be securely affixed to the floating support 14A and the rear cover 22A respectively so as to evenly distribute the pulling force between the floating support 14A and the rear cover 22A.

It is worth mentioning that the album may only comprise one sliding arrangement 30A which is provided between the rear cover 22A and the floating support 14A. An outer edge of the front cover 21A may be affixed to an outer edge of the floating support 14A by glues, such that when at the opened position, the album pages 23A are concurrently and slidably shifted on the floating support 14A via the sliding arrangement 30A provided between the rear cover 22A and the floating support 14A. The single one sliding arrangement 30A also can be provided between the front cover 21A of the album retainer 20A and the floating support 14A.

The outer case 10A further comprises a plurality of retention members 15A, for example four retention members 15A, inwardly extended from end walls of the first and second case bodies 11A and 12A respectively for retain the supporting support 14A in the outer case 10A. Accordingly, each of the retention members 15A can be embodied as a protrusion member inwardly extended from a mid-section of an end wall respectively. Accordingly, the retention members 15A also prevent the further movement of the floating support 14A when the floating support 14A is elevated at the opened position.

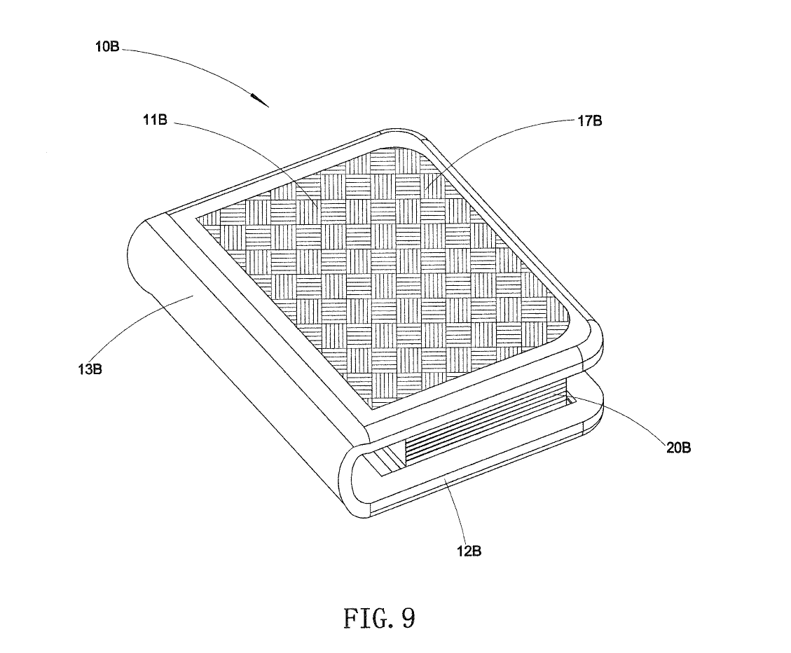

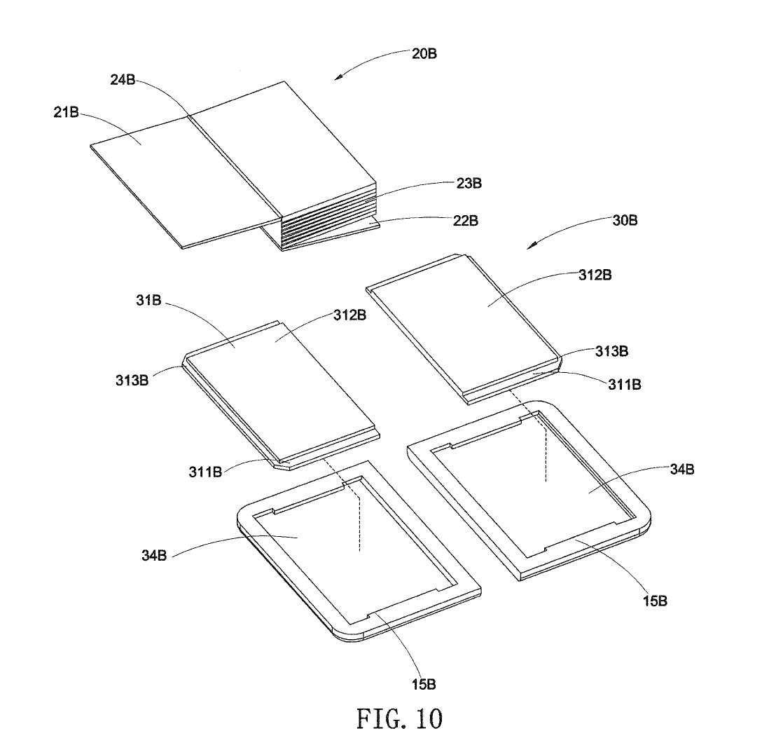

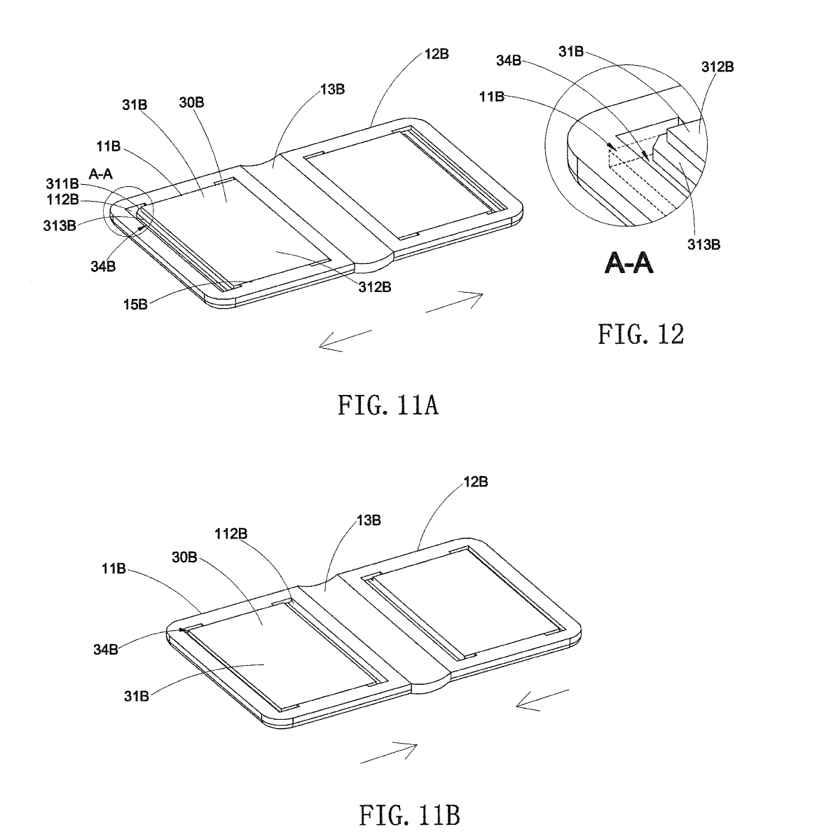

Referring to FIGS. 9 to 13 of the drawings, an album according to a third preferred embodiment of the present invention is illustrated, wherein the album comprises a book-like album cover 10B, an album retainer 20B, and one or more sliding arrangements 30B.

The book-like album cover 10B comprises a front panel 11B, a rear panel 12B, and a spine panel 13B extending between the front and rear panels 11B and 12B edge-to-edge.

The album retainer 20B comprises a front cover 21B, a rear cover 22B, and a plurality of album pages 23B overlapping between the front cover 21B and the rear cover 22B. Inner edges of the front cover 21B, the rear cover 22B, and the plurality of album pages 23B are bonded with each other so that the user is able to turn from the front cover 21B to the rear cover 22B for viewing the plurality of album pages 23B when the album is at an opened position.

The album retainer 20B further comprises a plurality of edge leaves 24B connecting the inner edges of the album pages 23B respectively, wherein each of the edge leaves 24B coupling between two sequent album pages at a position that the inner edges of the sequent album pages are spaced apart from each other such that two neighboring album pages are aligned in a planar manner when the neighboring album pages are folded to overlap on the front and rear covers 21B and 22B respectively at the opened position.

The album of this preferred embodiment can comprise one sliding arrangement 30B for coupling with one of the front and rear covers 21B and 22B of the album retainer 20B. Preferably, the album of this preferred embodiment comprises two sliding arrangements 30B for coupling with the front and rear covers 21B and 22B respectively.

As an example of the sliding arrangement 30 which is provided for coupling with the front cover 21B, the sliding arrangement 30B has a sliding cavity 34B defined in the front panel 11B and comprises a sliding member 31B slidably movable in the sliding cavity 34B. As shown in the drawings, two retention elements 15B, which are embodied as two elongated edges, are respectively extended from lateral inner edges 111B of the front panel 11B. Two retention members 15B are respectively coupled with the side edges of the sliding member 31B in such a manner that each of the two retention members 15B is slidably sandwiched in a sliding slot 311B of the side edge of the sliding member 31B. In other words, the sliding member 31B is retained in the sliding cavity 34B via the two retention members 15B. Alternatively, the sliding member 31B comprises an affixing sheet 312B for coupling with the front cover 21B of the album retainer 20B and a sliding sheet 313B which is spacedly and overlappedly aligned with the affixing sheet 312B for sliding in the sliding cavity 34B. The sliding slot 311B is defined between the affixing sheet 312B and the sliding sheet 313B.

It is worth mentioning that a clearance 112B can be defined between the retention members 15B and the end edges 113B of the front panel 11B, so as to facilitate the installation of the sliding member 31B. In other words, the sling member 31B can be embedded into the sling cavity 34B through the clearance 11B so as to couple with the two retention members 15B, a width of the sliding member 31B is smaller than a width of the sliding cavity 34B. The clearance 112B also provides a space for the free sliding movement of the sliding member 31B.

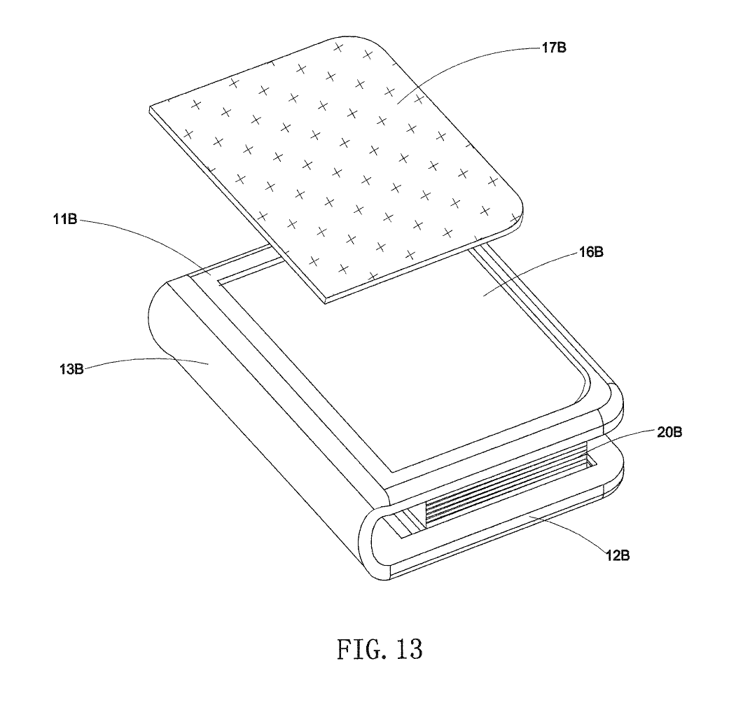

Referring to FIG. 13 of the drawings, one or more receiving notches 16B may be provided in the outer surface of the album. According to this preferred embodiment, two receiving notches 16B are respectively provided in the outer surfaces of the front and rear panels 11B and 12B, so that two cover boards 17B with beautiful appearances can be embedded into the receiving notches 15B respectively for enhancing the aesthetic outer appearance of the album.

In other words, some cover boards 17B, which have nice patterns cannot directly used to wrap around the album retainer 20B, can be affixed to the front and rear panels 11B and 12B to enhance the aesthetic outer appearance of the album. For example, the cover boards 17B can be respectively affixed with front and rear panels 11B and 12B in the receiving notches 16B via glues.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An album, comprising:
an album retainer, wherein said album retainer comprises a front cover, a rear cover, and a plurality of album pages overlapping between said front cover and said rear cover, wherein inner edges of said album pages are bound with each other; and
one or more sliding arrangements arranged for coupling with at least one of said front cover and said rear cover in such a manner that at least one of said front cover and said rear cover is retained in a slidably movable manner so as to provide a planar backing for said plurality of album pages when said album is at an opened position.

2. The album, as recited in claim 1, one of said sliding arrangements comprises a sliding member coupling with said rear cover to retain said rear cover in a slidably movable manner.

3. The album, as recited in claim 1, wherein an outer edge of said rear cover is affixed to an outer edge of said sliding member.

4. The album, as recited in claim 1, further comprising a floating support mounted in said album for supporting said album retainer, wherein when said album is at said opened position, said album retainer is elevated above said outer case by said floating support for a user to view said album pages, wherein at least one of said front and rear covers is slidable on said floating support via said sliding arrangements.

5. The album, as recited in claim 3, further comprising a floating support mounted in said album for supporting said album retainer, wherein when said album is at said opened position, said album retainer is elevated above said outer case by said floating support for a user to view said album pages, wherein at least one of said front and rear covers is slidable on said floating support via said sliding arrangements.

6. The album, as recited in claim 1, further comprising an outer case defining a receiving cavity, wherein said album retainer is received in said receiving cavity, wherein said outer case comprises an upper cover and a lower case body foldably coupled with said upper cover to define said receiving cavity.

7. The album, as recited in claim 5, further comprising an outer case defining a receiving cavity, wherein said album retainer is received in said receiving cavity, wherein said outer case comprises an upper cover and a lower case body foldably coupled with said upper cover to define said receiving cavity.

8. The album, as recited in claim 6, wherein said floating support comprises a first support body overlapping with said upper cover and a second support body overlapping with said lower case body, wherein said front cover is affixed to said first support body of said floating support while said rear cover is capable of sliding on said second support body of said floating support via said sliding arrangement.

9. The album, as recited in claim 7, wherein said floating support comprises a first support body overlapping with said upper cover and a second support body overlapping with said lower case body, wherein said front cover is affixed to said first support body of said floating support while said rear cover is capable of sliding on said second support body of said floating support via said sliding arrangement

10. The album, as recited in claim 8, wherein said upper cover defines an outer edge, wherein said first support body of said floating support has a first outer edge mounted to said outer edge of said upper cover, wherein said lower case body defines an inner bottom wall and a plurality of side walls extended from said inner bottom wall so as to define said receiving cavity, wherein said lower case body has an outer side wall pivotally extended from said inner bottom wall, and said second support body of said floating support defines a second outer edge inwardly mounted to an outer rim of said outer side wall in such a manner that said floating support is inwardly extended between said outer rim of said outer side wall of said lower case body and said outer edge of said upper cover, wherein when said album is at said opened position, said outer edge of said upper cover and said outer rim of said outer side wall of said lower case body retain said floating support in an elevated position to support said album retainer.

11. The album, as recited in claim 9, wherein said upper cover defines an outer edge, wherein said first support body of said floating support has a first outer edge mounted to said outer edge of said upper cover, wherein said lower case body defines an inner bottom wall and a plurality of side walls extended from said inner bottom wall so as to define said receiving cavity, wherein said lower case body has an outer side wall pivotally extended from said inner bottom wall, and said second support body of said floating support defines a second outer edge inwardly mounted to an outer rim of said outer side wall in such a manner that said floating support is inwardly extended between said outer rim of said outer side wall of said lower case body and said outer edge of said upper cover, wherein when said album is at said opened position, said outer edge of said upper cover and said outer rim of said outer side wall of said lower case body retain said floating support in an elevated position to support said album retainer.

12. The album, as recited in claim 1, further comprising an outer case defining a receiving cavity, wherein said album retainer is received in said receiving cavity, wherein said outer case comprises a first case body and a second case body foldably coupled with said first case body to define said receiving cavity.

13. The album, as recited in claim 12, further comprising a floating support mounted in said outer case for supporting said album retainer, wherein when said album is at said opened position, said album retainer is elevated above said outer case by said floating support for a user to view said album pages, wherein said front and rear covers are respectively slidable on said floating support via said sliding arrangements.

14. The album, as recited in claim 13, wherein at least one of said sliding arrangements comprises a flexible sheet having two longitudinal edges coupling at an outer side of said rear cover and inner side of said floating support to retain said album pages being overlapped on said rear cover in a slidable movable manner.

15. The album, as recited in claim 14, wherein said flexible sheet, having an elongated structure, defines said two longitudinal edges extending in a parallel manner and coupling at mid-sections of said rear cover and said floating support respectively.

16. The album, as recited in claim 15, wherein said sliding arrangement further comprises a first retention sheet overlappedly affixed to said outer side of said rear cover to retain on of said longitudinal edges of said flexible sheet in position, and a second retention sheet overlappedly affixed to said inner side of said floating support to retain another said longitudinal edge of said flexible sheet in position, such that said first and second retention sheets hold said rear cover being overlapped on said floating support in a slidable movable manner.

17. The album, as recited in claim 16, wherein an outer edge of said front cover is affixed to an outer edge of said floating support.

18. The album, as recited in claim 16, further comprising another said sliding arrangement provided between said front cover and said floating support in such a manner that said front cover is coupled with said floating support in a slidable movable manner.

19. The album, as recited in claim 16, wherein said floating support comprises a first support body overlapping with said first case body and a second case body overlapping with said second support body.

20. The album, as recited in claim 16, wherein said first support body are integrated with said second support body to form a one-piece structure.

21. The album, as recited in claim 16, wherein said first support body and said second support body are independent components respectively mounted to said first and second case bodies.

22. The album, as recited in claim 11, wherein said lower case body further defines two end walls, wherein said outer case further comprises two retention members inwardly extended from said two end walls respectively for retain said sliding member in said outer case in such a manner that said sliding member slides on said floating support below said two retention members.

23. The album, as recited in claim 22, wherein said two retention members are respectively elongated edges inwardly extended from said two end wall of said lower case body.

24. The album, as recited in claim 16, wherein said outer case further comprises a plurality of retention members inwardly extended from said first and second case bodies, wherein each of said retention members is a protrusion member.

25. The album, as recited in claim 11, wherein each of said album pages made of photo printable material that a photo is directly printed on each of said album, wherein said album retainer further comprises a plurality of edge leaves connecting said inner edges of said album pages respectively.

26. The album, as recited in claim 25, wherein inner sides of said front and rear covers are respectively used for displaying photos.

27. An album, comprising:
a book-like album cover which comprises a front panel, a rear panel, and a spine panel extending between said front and rear panels in an edge-to-edge manner;
an album retainer, wherein said album retainer comprises a front cover, a rear cover, and a plurality of album pages overlapping between said front cover and said rear cover, wherein inner edges of said album pages are bound with each other; and
one or more sliding arrangements arranged for coupling with at least one of said front cover and said rear cover with said front and rear panels in such a manner that at least one of said front cover and said rear cover is retained in a slidably movable manner so as to provide a planar backing for said plurality of album pages when said album is at an opened position.

28. The album, as recited in claim 27, wherein said album comprises two said sliding arrangements for coupling with said front and rear covers respectively, wherein each of said sliding arrangement comprises a sliding member, wherein said two sliding arrangements have sliding cavities defined in the front and rear cover respectively, wherein each of said sliding member slides in said sliding cavity so as to allow said front panel, said rear panel, and said spine panel to form said planar backing.

29. The album, as recited in claim 27, further comprising a plurality of retention elements, which are elongated edges, respectively extended from lateral inner edges of the front and rear panels, wherein said retention members are respectively coupled with side edges of said sliding member in such a manner that each of said retention members is slidably sandwiched in a sliding slot defined between said side edge of said sliding member.

30. The album, as recited in claim 27, wherein each of said album pages made of photo printable material that a photo is directly printed on each of said album, wherein said album retainer further comprises a plurality of edge leaves connecting said inner edges of said album pages respectively.

31. The album, as recited in claim 28, wherein a width of said sliding member is smaller than a width of said sliding cavity so as to define a clearance therewithin for a free sliding movement of said sliding member.

32. The album, as recited in claim 27, wherein at least one receiving notch is provided in an outer surface of said album cover, wherein at least one cover board is affixed to said outer surface of said album cover within said receiving notch.

33. The album, as recited in claim 32, wherein each of said cover boards, which is made of relatively rid materials, has an aesthetic pattern thereon.

34. A method of manufacturing an album, comprising the following steps:
(a) providing an album retainer which comprises a front cover, a rear cover, and a plurality of album pages overlapping between said front cover and said rear cover, wherein inner edges of said album pages are bound with each other; and
(b) slidably retaining at least one of said front cover and said rear cover via at least one sliding arrangement so as to provide a planar backing for said plurality of album pages when said album is at an opened position.

35. The method, as recited in claim 34, further comprising a step of receiving said album retainer via an outer case including an upper cover and a lower case body foldably coupled with said upper cover.

36. The method, as recited in claim 34, further comprising a step of receiving said album retainer via an outer case including a first case body and a second case body foldably coupled with said first case body.

37. The method, as recited in claim 35, further comprising a step of elevating said album retainer above said outer case via a floating support, wherein at least one of said front and rear covers is slidable on said floating support.

38. The method, as recited in claim 36, further comprising a step of elevating said album retainer above said outer case via a floating support, wherein at least one of said front and rear covers is slidable on said floating support.

39. The method, as recited in claim 27, further comprising a step of sliding a sliding member of said sliding arrangement on said floating support so as to provide said planar backing, wherein said sliding member is affixed with said rear cover.

40. The method, as recited in claim 27, further comprising a step of retaining said sliding member on said floating support through a plurality of retention members which are inwardly extended from end walls of said case body.

41. The method, as recited in claim 38, wherein the step (b) further comprises a step of coupling two longitudinal edges of a flexible sheet at an outer side of said rear cover and an inner side of said floating support to retain said rear cover being overlapped on said floating support in a slidably movable manner.

42. The method, as recited in claim 41, wherein the step (b) further comprises a step of overlappedly affixing a first retention sheet to said outer side of said rear cover to retain one of said longitudinal edges of said flexible sheet in position, and a step of overlappedly affixing a second retention sheet to said inner side of said floating support to retain another said longitudinal edge of said flexible sheet in position, such that said first and second retention sheets hold said rear cover being overlapped on said floating support in a slidably movable manner.
